(19) United States
(12) Patent Application Publication
(10) Pub. No.: US 2017/0068364 A1
(43) Pub. Date: Mar. 9, 2017

(54) DISPLAY MODULE AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD, Hefei (CN)

(72) Inventors: Jun XU, Beijing (CN); Qing ZHANG, Beijing (CN)

(21) Appl. No.: 15/079,077

(22) Filed: Mar. 24, 2016

(30) Foreign Application Priority Data
Sep. 9, 2015 (CN) 201510570720.6

(51) Int. Cl. G06F 3/041

(52) U.S. Cl. CPC G06F 3/0412; G06F 2203/04103

(57) ABSTRACT

A display module is divided into a display area and a non-display area surrounding a periphery of the display area, comprises a touch panel and a liquid crystal panel which are assembled, an optical processing film is provided between the touch panel and the liquid crystal panel, wherein the optical processing film is provided in the display area, an adhesive block, which is provided in an area corresponding to the non-display area between the touch panel and the liquid crystal panel, surrounds a periphery of the optical processing film and is provided in the same layer as the optical processing film, has the same thickness as the optical processing film, the adhesive block is configured to adhere the touch panel to the liquid crystal panel as a whole. Thinness of the display module can be achieved and the corresponding display device can achieve the effect of narrow frame.

### FIELD OF THE INVENTION

The present invention relates to the field of display technology, and particularly to a display module and a display device.

### BACKGROUND OF THE INVENTION

With the development of social informationization, people's demand on the information display development is larger. At present, the most common display mode on the market is liquid crystal display, a corresponding liquid crystal display achieves a grayscale display through controlling the liquid crystal molecules to rotate using an electric field, and then achieves a color display by using color filters. Liquid crystal displays have been widely used in computers, TVs and display devices of mobile terminals due to their excellent properties such as thinness, lightweight, low power consumption.

Display module is a main component in the liquid crystal display, and is formed by attaching a liquid crystal module (LCM) to a touch panel (TP). Current attachment manner mainly includes two kinds, a full attachment and a frame attachment, wherein the frame attachment products have a larger market due to their low prices. For structure parameters of a product, the full attachment casues thickness of the display module to be increased by a thickness of the adhesive layer, so that the whole thickness of the product is large; the frame attachment causes the thickness of the display module to be increased by a thickness of an air layer, so that the whole thickness of the product is also large. FIG. 1 is a structural diagram of a display module using the frame attachment in the prior art, as shown in FIG. 1, a liquid crystal panel 3 comprises a color filter polarizer 31, a color filter substrate 32, an array substrate 33 and an array polarizer 34. An optically clear adhesive (OCA) 2 is provided between the touch panel 1 and the color filter polarizer 31, for attaching the touch panel 1 to liquid crystal panel 3 as a whole. Such an attachment manner may form an air layer 21 between the touch panel 1 and the color filter polarizer 31, so that the whole display module becomes larger in thickness, for example, generally, after a liquid crystal panel 3 of 15.6 inches is attached to the touch panel 1, a total thickness may reach 4.6 mm, in which the thickness of the liquid crystal panel 3 is 3.1 mm, the thickness of the OCA 2 is 0.7 mm and the thickness of the touch panel 1 is 0.8 mm. Also, the thickness of a display module using the full attachment may reach 4.1 mm, in which the thickness of the adhesive layer (OCR, optical clear resin) is 0.3 mm.

At present, the display module formed by using the frame attachment manner or the full attachment manner in the prior art has a relative large thickness, which is contrary to the trend of consumer's pursuit for thin electronic products. Moreover, a corresponding display device formed by using the above display module can not achieve the effect of narrow frame, which is contrary to the trend of thinness, and has high manufacture cost.

### SUMMARY OF THE INVENTION

In view of the above shortcomings in the prior art, the present invention provides a display module and a display device, the display module incorporates the frame attachment manner and the full attachment manner in the prior art, that is, possesses the properties of no air layer in the full attachment manner and no adhesive layer in the frame attachment manner. Therefore, thinness of the display module can be achieved, and the corresponding display device can achieve the effect of narrow frame, and the manufacture cost is decreased.

A solution adopted to solve the problem in the invention is a display module, which is divided into a display area and a non-display area surrounding a periphery of the display area, and comprises a touch panel and a liquid crystal panel which are aligned and assembled, an optical processing film is provided between the touch panel and the liquid crystal panel, wherein the optical processing film is provided in the display area, an adhesive block, which is provided in an area corresponding to the non-display area between the touch panel and the liquid crystal panel, surrounds a periphery of the optical processing film and is provided in the same layer as the optical processing film, has the same thickness as the optical processing film, the adhesive block is configured to adhere the touch panel to the liquid crystal panel as a whole.

Preferably, the liquid crystal panel comprises a color filter substrate, the optical processing film is a color filter polarizer, and the adhesive block is provided between boundaries of the color filter polarizer and the color filter substrate.

Preferably, the adhesive block is of a discontinuous ring structure which is provided around the boundaries of the color filter polarizer.

Preferably, a width of each side of the discontinuous ring structure is larger than or equals to 2 mm, and is smaller than or equals to a distance from the boundary of the color filter polarizer to the corresponding boundary of the color filter substrate.

Preferably, the distance from the boundary of the color filter polarizer to the boundary of the corresponding color filter substrate is 3-4 mm.

Preferably, the display module further comprises an anti-newton ring explosion-proof film, which is provided on a surface of the touch panel close to the optical processing film.

A display device, comprising a package frame, a fixing member, a connection member, a backlight module, and the above display module, wherein the backlight module is provided at a side of the liquid crystal panel away from the touch panel, the display module and the backlight module are connected integrally by the fixing member, the package frame is configured to package the display module and the backlight module, the connection member is configured to fix the display module to the package frame.

Preferably, the touch panel extends above the package frame, the connection member is a double sided adhesive tape, is provided outside the adhesive block and is adhered between the touch panel and the package frame and is configured to connect the display module and the package frame as a whole.

Preferably, the connection member includes connection screws, the liquid crystal panel is provided with lug structures thereoutside, each of lug structures is provided therein with a through hole for the connection screw to pass through, the package frame is provided with threaded holes at positions corresponding to the through holes, the connection screws connect the display module and the package frame as a whole by passing through the through holes and the threaded holes.

Preferably, the connection member is an adhesive layer, which is provided between the backlight module and the package frame, for connecting the display module and the package frame as a whole.

Advantages of the present invention are in that: the display module incorporates the frame attachment manner and the full attachment manner in the prior art, that is, possesses the properties of no air layer in the full attachment manner and no adhesive layer in the frame attachment manner. Therefore, thinness of the display module can be achieved, and the corresponding display device can achieve the effect of narrow frame, and the manufacture cost is decreased.

### BRIEF DESCRIPTION OF THE DRAWINGS

FIG. 1 is a structural diagram of a display module using the frame attachment manner in the prior art;

FIG. 2 is a structural diagram of a display module in an embodiment 1 in the present invention;

FIG. 3 is a structural diagram of a display device in an embodiment 2 in the present invention;

FIG. 4 is a structural diagram of a display device in an embodiment 3 in the present invention;

FIG. 5 is a structural diagram of a display device in an embodiment 4 in the present invention;

wherein:

1—touch panel; 100—anti-newton ring explosion-proof film; 2—adhesive frame; 21—air layer; 3—liquid crystal panel; 31—color filter polarizer; 32—color filter substrate; 33—array substrate; 34—array polarizer; 4—adhesive block; 5—frame; 6—backlight module; 7—adhesive tape; 8—double sided adhesive frame; 9—package frame; 91—upper package frame; 92—lower package frame; 10—lug structure; 11—connection screw; 12—adhesive layer; and 13—isolation layer.

### DETAILED DESCRIPTION OF THE EMBODIMENTS

To make those skilled in the art better understand the technical solutions of the present invention, the display module and the display device in the present invention will be described below in details in conjunction with the embodiments and the accompanying drawings.

### Embodiment 1

This embodiment provides a display module, which incorporates the frame attachment manner and the full attachment manner in the prior art, that is, possesses the properties of no air layer in the full attachment manner and no adhesive layer in the frame attachment manner, achieving the thinness of the display module.

The display module is divided into a display area and a non-display area surrounding a periphery of the display area, and comprises a touch panel and a liquid crystal panel which are aligned and assembled, an optical processing film is provided between the touch panel and the liquid crystal panel, wherein the optical processing film is provided in the display area, an adhesive block, which is provided in an area corresponding to the non-display area between the touch panel and the liquid crystal panel, surrounds a periphery of the optical processing film and is provided in the same layer as the optical processing film, has the same thickness as the optical processing film, the adhesive block is configured to adhere the touch panel to the liquid crystal panel as a whole.

Specific structures of the display module are shown in FIG. 2, a liquid crystal panel 3 comprises an optical processing film, a color filter substrate 32, an array substrate 33 and an array polarizer 34, wherein the optical processing film herein is a color filter polarizer 31 and correspondingly provided in the display area of the display module. An adhesive block 4, which is provided in the non-display area of the display module, surrounds a periphery of the color filter polarizer 31 and is provided in the same layer as the color filter polarizer 31, has the same thickness as the color filter polarizer 31, the adhesive block 4 is configured to adhere the touch panel 1 to the liquid crystal panel 3 as a whole. Material of the adhesive block 4 may be any adhesive material for adhering the touch panel to the liquid crystal panel in the prior art. Also, the material of the adhesive block 4 may be an adhesive frame material, for example, FIG. 2 shows an example in which the adhesive block and the adhesive frame are of the same material (it is all the same to embodiments in FIGS. 3-5).

The display module incorporates the frame attachment manner and the full attachment manner in the prior art, that is, possesses not only the property of no air layer in the full attachment manner, but also the property of no adhesive layer in the frame attachment manner, thinness of the display module can be achieved, and the manufacture cost can be decreased.

Specifically, the adhesive block 4 is provided between boundaries of the color filter polarizer 31 and the color filter substrate 32. That is to say, the adhesive block 4 is located outside the color filter polarizer 31 and does not extend to the boundaries of the color filter substrate 32, that is, projection of the adhesive block 4 on the color filter substrate 32 falls within an area of upper surface of the color filter substrate 32.

Preferably, a distance from the boundary of the color filter polarizer 31 to the boundary of the color filter substrate 32 adjacent thereto is 3-4 mm, that is, the minimum distance from a side surface of the color filter polarizer 31 to an adjacent corresponding side surface of the color filter substrate 32 is in a range of 3-4 mm, so as to leave enough room for providing the adhesive block 4. The adhesive block 4 is provided around the periphery of the color filter polarizer 31 and has a shape corresponding to that of the color filter polarizer 31, and preferable of a discontinuous ring structure which means that the adhesive block 4 is formed of a discontinuous and intermittent ring structure around the periphery of the color filter polarizer 31, thus adhesive material can be saved. Certainly, the adhesive block 4 may be of an enclosed ring structure which means that the adhesive block 4 is formed of an enclosed ring structure around the periphery of the color filter polarizer 31. In practices, the discontinuous ring structure or the enclosed ring structure may be selected as needed, which is not limited herein.

Meanwhile, to ensure enough adhesion of the adhesive block 4, a width of the adhesive block 4 at each side of the color filter polarizer 31 is preferably larger than or equal to 2 mm, that is, no matter the adhesive block 4 is of the discontinuous ring structure or the enclosed ring structure, the width of the ring path of the adhesive block 4 is larger than or equals to 2 mm.

An anti-newton ring explosion-proof film 100 is provided on a surface of the touch panel 1 close to the color filter polarizer 31. The anti-newton ring explosion-proof film 100 functions to prevent glass shards from splashing when the touch panel 1 is damaged to be broken, and may also effectively avoid the generation of newton ring phenomenon. Moreover, the anti-newton ring explosion-proof film 100 herein may be a common explosion-proof film, which may be provided with a plurality of protrusions on a surface thereof close to the color filter polarizer 31, the protrusions may significantly reduce the degree of depression of the middle part of the touch penal 1 towards the liquid crystal panel 3 when a force is exerted on the touch panel 1, effectively avoiding the generation of newton ring phenomenon.

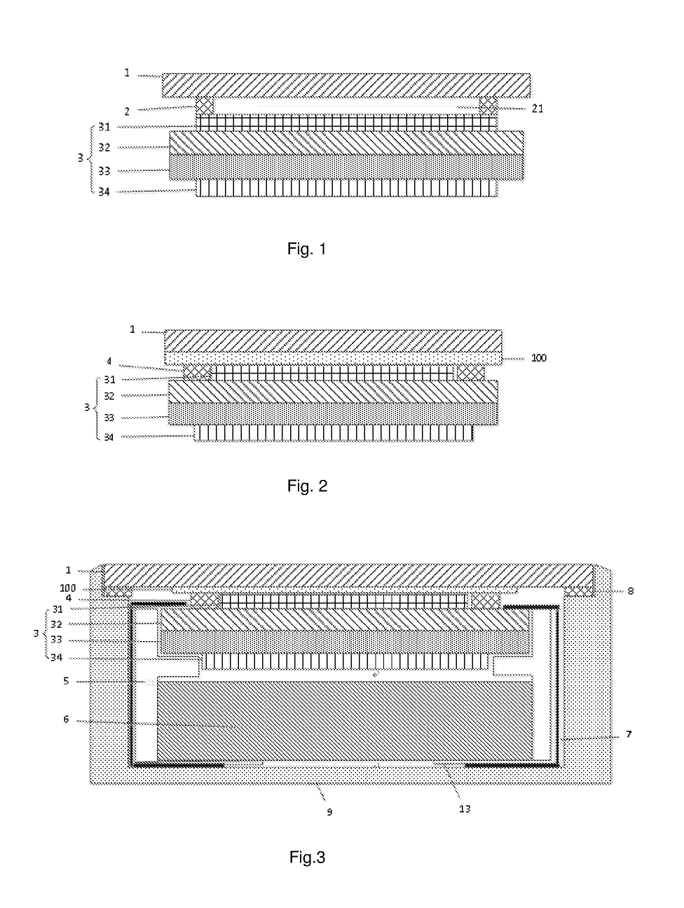

Compared with the display module shown in FIG. 1 in the prior art, there is no air layer 21 in the display module of this embodiment, the display module after above attachment has a thickness of 3.9 mm, thus the total thickness of the display module is reduced and thinness of the product can be achieved. Moreover, since the anti-newton explosion-proof film 100 with protrusions is adopted, glass shards may be prevented from splashing when the touch panel 1 is damaged to be broken, and the generation of newton ring phenomenon may also be effectively avoid.

### Embodiment 2

This embodiment provides a display device, which comprises a package frame, a fixing member, a connection member and a backlight module, and further comprises the display module in embodiment 1, wherein the backlight module is provided at a side of the liquid crystal panel away from the touch panel, the package frame is configured to package the display module and the backlight module; the connection member is configured to fix the display module inside the package frame. In a case that the display module has a small thickness, the display device achieves the effect of narrow frame, and has low manufacture cost.

As shown in FIG. 3, the display module is correspondingly provided so as to be spaced with the backlight module 6 by a frame 5, and the display module, the frame 5 and the backlight module 6 are connected as a whole by using an adhesive tape 7, wherein, isolation layers 13 are provided between the adhesive tape 7 and the frame 5 and between the adhesive tape 7 and the backlight module 6, and are used to disenable the backlight module 6 to directly contact the adhesive tape 7.

The touch panel 1 in the display device extends above the package frame 9, that is, the area of a lower surface of the touch panel 1 is larger than a sum area of an upper surfaces of the color filter substrate 32 and the frame 5, meanwhile, projections of the color filter substrate 32 and the frame 5 on the touch panel 1 fall within a region range of a lower surface of the touch panel 1, a region on the lower surface of the touch panel 1 beyond the projections of the color filter substrate 32 and the frame 5 is used to be connected with the package frame 9, the connection member adopted is a double sided adhesive tape 8, accordingly, the double sided adhesive tape 8 is also provided outside the adhesive block 4 and connects the display module and the package frame 9 as a whole.

The display device adopts the display module in the embodiment 1, achieves the effect of narrow frame, and is of simple structure and can be manufactured easily.

### Embodiment 3

This embodiment provides a display device, which is different from that in the embodiment 2 is in that: in this embodiment, the area of the lower surface of the touch panel 1 of the display device is substantially the same as the sum area of the upper surfaces of the color filter substrate 32 and the frame 5, thus the utilization rate of the glass used in the manufacture process can be largely increased, and the manufacture cost is decreased. More importantly, the connection member for connecting the display module and the package frame as whole in the display device in this embodiment includes connection screws.

As shown in FIG. 4, the area of the lower surface of the touch panel 1 is substantially the same as the sum area of the upper surfaces of the color filter substrate 32 and the frame 5. Compared to the display device in the embodiment 2, the display panel 1 included in the display device in this embodiment has a smaller size, thus less glass material is needed, the utilization rate of the glass is higher and the manufacture cost is lower.

Moreover, the liquid crystal panel is provided with lug structures 10 thereoutside, and the lug structures 10 are connected to the frame 5. Each of lug structures is provided therein with a through hole for the connection screw 11 to pass through, the package frame 9 is divided into an upper package frame 91 and a lower package frame 92, bottom surface of the lower package frame 92 is provided with threaded holes corresponding to the through holes on the lug structures 10. Before the upper package frame 91 is assembled, the connection screw 11 passes through the through hole on the lug structure 10 and screwed into the threaded hole on the bottom surface of the lower package frame 92, so that the display module, the backlight module and 8 the package frame 9 are connected as a whole, hereafter, the upper package frame 91 is assembled with the lower package frame 92, and assembly of the display device in this embodiment is completed.

Other structures and components of the display device in this embodiment are the same as those of the embodiment 2, which will not be repeatedly described herein.

This display device also adopts the display module in the embodiment 1, the effect of narrow frame is achieved, less glass material is used, the utilization rate the glass is increased and the manufacture cost is decreased.

### Embodiment 4

This embodiment provides a display device, which is different from that in the embodiment 2 is in that: in this embodiment, the area of the lower surface of the touch panel 1 of the display device is substantially the same as the sum area of the upper surfaces of the color filter substrate 32 and the frame 5, thus the utilization rate of the glass used in the manufacture process can be largely increased, and the manufacture cost is decreased. More importantly, the connection member for connecting the display module and the package frame as whole in the display device in this embodiment is an adhesive layer 12.

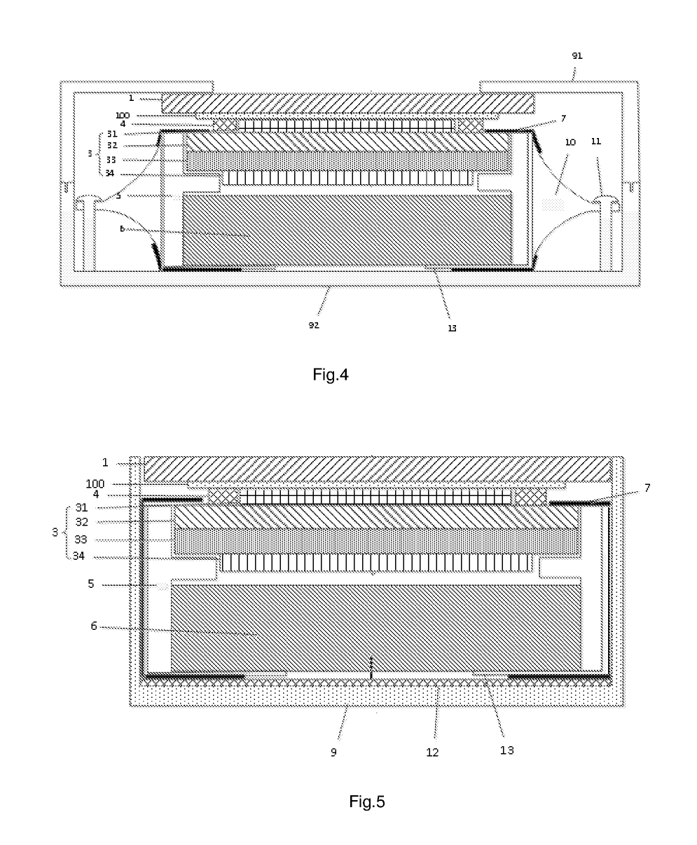

As shown in FIG. 5, the touch panel 1 of the display device in this embodiment has the same structure as the touch panel 1 in the embodiment 3, thus the utilization rate the glass is higher and the manufacture cost is lower.

In addition, the adhesive layer 12 as the connection member is provided between the backlight module 6 and the package frame 9, for connecting the display module and the package frame 9 as a whole.

Other structures and components of the display device in this embodiment are the same as those of the embodiment 2, which will not be repeatedly described herein.

This display device also adopts the display module in the embodiment 1, thus the effect of narrow frame is achieved, less glass material is used, the utilization rate the glass is increased and the manufacture cost is decreased.

It is to be understood, the foregoing implementations are merely exemplary embodiments for explaining the principle of the present invention, and the present invention is not limited thereto. Various modifications and improvements can be made for those skilled in the art without departing from the spirit and essence of the present invention, and these modifications and improvements shall also fall within the scope of the present invention.

What is claimed is:

1. A display module, which is divided into a display area and a non-display area surrounding a periphery of the display area, and comprises a touch panel and a liquid crystal panel which are aligned and assembled, an optical processing film is provided between the touch panel and the liquid crystal panel, wherein the optical processing film is provided in the display area, an adhesive block, which is provided in an area corresponding to the non-display area between the touch panel and the liquid crystal panel, surrounds a periphery of the optical processing film and is provided in the same layer as the optical processing film, has the same thickness as the optical processing film, the adhesive block is configured to adhere the touch panel to the liquid crystal panel as a whole.

2. The display module of claim 1, wherein the liquid crystal panel comprises a color filter substrate, the optical processing film is a color filter polarizer, and the adhesive block is provided between boundaries of the color filter polarizer and the color filter substrate.

3. The display module of claim 2, wherein the adhesive block is of a discontinuous ring structure which is provided around the boundaries of the color filter polarizer.

4. The display module of claim 3, wherein a width of each side of the discontinuous ring structure is larger than or equals to 2 mm, and is smaller than or equals to a distance from the boundary of the color filter polarizer to the corresponding boundary of the color filter substrate.

5. The display module of claim 4, wherein the distance from the boundary of the color filter polarizer to the corresponding boundary of the color filter substrate is 3˜4 mm.

6. The display module of claim 1, further comprising an anti-newton ring explosion-proof film, which is provided on a surface of the touch panel close to the optical processing film.

7. The display module of claim 2, further comprising an anti-newton ring explosion-proof film, which is provided on a surface of the touch panel close to the optical processing film.

8. The display module of claim 3, further comprising an anti-newton ring explosion-proof film, which is provided on a surface of the touch panel close to the optical processing film.

9. The display module of claim 4, further comprising an anti-newton ring explosion-proof film, which is provided on a surface of the touch panel close to the optical processing film.

10. The display module of claim 5, further comprising an anti-newton ring explosion-proof film, which is provided on a surface of the touch panel close to the optical processing film.

11. A display device, comprising a package frame, a fixing member, a connection member, a backlight module, and the display module of claim 1, wherein the backlight module is provided at a side of the liquid crystal panel away from the touch panel, the display module and the backlight module are connected integrally by the fixing member, the package frame is configured to package the display module and the backlight module, the connection member is configured to fix the display module to the package frame.

12. The display device of claim 11, wherein the touch panel extends above the package frame, the connection member is a double sided adhesive tape, is provided outside the adhesive block and is adhered between the touch panel and the package frame and is configured to connect the display module and the package frame as a whole.

13. The display device of claim 11, wherein the connection member includes connection screws, the liquid crystal panel is provided with lug structures thereoutside, each of lug structures is provided therein with a through hole for the connection screw to pass through, the package frame is provided with threaded holes at positions corresponding to the through holes, the connection screws connect the display module and the package frame as a whole by passing through the through holes and the threaded holes.

14. The display device of claim 11, wherein the connection member is an adhesive layer, which is provided between the backlight module and the package frame, for connecting the display module and the package frame as a whole.

15. A display device, comprising a package frame, a fixing member, a connection member, a backlight module, and the display module of claim 2, wherein the backlight module is provided at a side of the liquid crystal panel away from the touch panel, the display module and the backlight module are connected integrally by the fixing member, the package frame is configured to package the display module and the backlight module, the connection member is configured to fix the display module to the package frame.

16. A display device, comprising a package frame, a fixing member, a connection member, a backlight module, and the display module of claim 3, wherein the backlight module is provided at a side of the liquid crystal panel away from the touch panel, the display module and the backlight module are connected integrally by the fixing member, the package frame is configured to package the display module and the backlight module, the connection member is configured to fix the display module to the package frame.

17. A display device, comprising a package frame, a fixing member, a connection member, a backlight module, and the display module of claim 4, wherein the backlight module is provided at a side of the liquid crystal panel away from the touch panel, the display module and the backlight module are connected integrally by the fixing member, the package frame is configured to package the display module and the backlight module, the connection member is configured to fix the display module to the package frame.

18. A display device, comprising a package frame, a fixing member, a connection member, a backlight module, and the display module of claim 5, wherein the backlight module is provided at a side of the liquid crystal panel away from the touch panel, the display module and the backlight module are connected integrally by the fixing member, the package frame is configured to package the display module and the backlight module, the connection member is configured to fix the display module to the package frame.

19. A display device, comprising a package frame, a fixing member, a connection member, a backlight module, and the display module of claim 6, wherein the backlight module is provided at a side of the liquid crystal panel away from the touch panel, the display module and the backlight module are connected integrally by the fixing member, the package frame is configured to package the display module and the backlight module, the connection member is configured to fix the display module to the package frame.
